(19) United States
(12) Patent Application Publication
(10) Pub. No.: US 2025/0338380 A1
(43) Pub. Date: Oct. 30, 2025

(54) METHOD AND SYSTEM FOR CHECKING THE SETTING STATUS OF MULTIPLE LIGHT EMITTING DEVICES

(71) Applicant: HYBE Co., Ltd., Seoul (KR)

(72) Inventors: Bo Yoon CHOI, Seoul (KR); Sung Joo JEONG, Seoul (KR)

(73) Assignee: HYBE Co., Ltd., Seoul (KR)

(21) Appl. No.: 19/188,864

(22) Filed: Apr. 24, 2025

(30) Foreign Application Priority Data
Apr. 24, 2024 (KR) 10-2024-0054879

(51) Int. Cl. H05B 47/155; A63J 5/02; H05B 47/19

(52) U.S. Cl. CPC H05B 47/155; A63J 5/02; H05B 47/19

(57) ABSTRACT

A method for checking a setting status of multiple light emitting devices, executed by a performance setting application of a manager terminal, for monitoring setting status of the multiple light emitting devices, includes acquiring pairing information for the multiple light emitting devices, displaying setting status information for a first performance according to the acquired pairing information on a setting status interface at a first time point, determining at least one target seat according to the setting status information for the first performance, transmitting a setting encouragement message based on the determined target seat; providing feedback content for the setting status information of the first performance at a second time point after transmitting the setting encouragement message, and changing and storing performance direction data matched with the first performance according to the provided feedback content.

### CROSS REFERENCE TO RELATED APPLICATION(S)

This application claims priority to and benefits of Korean Patent Application No. 10-2024-0054879 under 35 U.S.C § 119, filed on Apr. 24, 2024, in the Korean Intellectual Property Office, the contents of which are incorporated herein by reference in its entirety.

### BACKGROUND

### 1. Technical Field

The disclosure relates to a method and a system for checking a setting status of multiple light emitting devices. More specifically, the disclosure relates to a method and a system for checking a setting status of the multiple light emitting devices, which indicates whether pairing based on a kiosk has been performed on light emitting devices and terminals carried by audience members seated in seats of an auditorium.

### 2. Description of the Related Art

In order to direct a performance using light emitting devices, each user may apply direction data in which emission of the light emitting devices is preset according to signature colors or musical rhythm of teams or artists of the performance to the light emitting devices.

In order to apply such direction data to the light emitting devices, a pairing service for transferring direction data to each light emitting device carried by each user at an auditorium has been launched according to related art.

The pairing service is usually performed by a kiosk installed in the auditorium, and since the auditorium accommodates a large number of people, multiple kiosks are installed so that audience members can perform pairing.

However, many audience members fail to perform the pairing as the audience members are unable to pair or do not know that the pairing is required, due to several reasons such as excessive use of kiosks or unstable internet environment.

Thus, there are problems in that, for example, a unified direction using light emitting devices is difficult, and the quality of the production is lowered due to a direction being different from an original intention.

Further, since a the status of pairing is reported by collecting the kiosks after the performance ends, individually logging in the kiosks, and adding up collected numbers, a performance manager or a performance director cannot know in real time which seats have performed the pairing and how many pairings have been performed relative to the number of people watching the performance, which causes problems in event setting and operating.

Therefore, a disclosure for statistically monitor how many audience members have performed pairing before the performance starts and encouraging pairing for audience members who need to perform the pairing has been discussed.

### SUMMARY

The disclosure has been made to solve the problems of the related art as described above, and an object of the disclosure is to provide a method and a system for checking a setting status of multiple light emitting devices, which provide setting status information indicating whether a light emitting device and an audience terminal located at each seat have completed pairing for operating with seat-specific direction data in a performance.

Another object of the disclosure is to provide a method and a system for checking a setting status of multiple light emitting devices, which transmit a setting encouragement message to seats at which pairing is essentially required.

Another object of the disclosure is to provide a method and a system for checking a setting status of multiple light emitting devices, which collect and monitor a real-time pairing proportion for each kiosk.

Another object of the disclosure is to provide a method and system for checking a setting status of multiple light emitting devices, which shift a target zone for operation with seat-specific direction data to a predetermined zone according to the setting status.

However, the disclosure and the objects of the disclosure are not limited to the objects described herein, and other technical objectives that are not mentioned herein would be clearly understood by a person skilled in the art from the description of the disclosure.

A method for checking a setting status of multiple light emitting devices according to an aspect of the disclosure may be a method, executed by a performance setting application of a manager terminal, checking a setting status of multiple light emitting devices, the method including: acquiring pairing information for the multiple light emitting devices; displaying setting status information for a first performance according to the acquired pairing information on a setting status interface at a first time point; determining at least one target seat according to the setting status information for the first performance; transmitting a setting encouragement message to the determined target seat; providing feedback content for the setting status information of the first performance at a second time point after transmitting the setting encouragement message; and changing and storing performance direction data matched with the first performance according to the provided feedback content.

Further, acquiring the pairing information may include linking with a master kiosk connected to at least one slave kiosk in which performing pairing with the multiple light emitting devices; and acquiring from the linked master kiosk the pairing information performed in at least one slave kiosk connected to the master kiosk.

Further, displaying the setting status information for the first performance may include extracting from the pairing information seat information matched with an audience terminal or a light emitting device that has received seat-specific direction data through pairing; determining the extracted seat information as paired seats; determining from the pairing information the remaining seat information, excluding the determined paired seats, as non-paired seats; and displaying a seat layout indicating the paired seats and the non-paired seats.

Further, displaying the setting status information for the first performance may include acquiring a total number of seats sold for the first performance from the performance management server; and calculating a pairing proportion that is a ratio of a number of the determined paired seats to the total number of seats, and the seat layout and the pairing proportion are displayed in real time on a setting status interface.

Further, determining the target seat may include acquiring the performance direction data for the first performance; determining a first direction scene from the acquired performance direction data; determining a first main set on a target seat determination interface based on a seat layout on which the first direction scene is indicated; classifying non-paired seats from the determined first main set; and determining at least one non-paired seat to be the target seat.

Further, transmitting the setting encouragement message may include determining either all audience terminals or only audience terminals matched with the determined target seats as recipient terminals, and determining all audience terminals as the recipient terminals includes generating the setting encouragement message in which the determined target seats are indicated in text format.

Further, the setting encouragement message may indicates at least one of floor number, row number, column number, and zone number of the target seats in an auditorium for the first performance.

Further, transmitting the setting encouragement message to all audience terminals as the recipient terminals may include extracting first seat information matched with a first audience terminal; comparing the target seats included in the setting encouragement message with the extracted first seat information; and controlling to provide a pairing guide to the first audience terminal when at least one of the target seats matches with the first seat information.

Further, providing the feedback content may include generating the feedback content indicating a first pairing proportion at the first time point and a second pairing proportion at the second time point; and providing an interface for shifting the first main set to another zone when the second pairing proportion is equal to or smaller than a preset criterion.

Further, changing and storing the performance direction data matched with the first performance may include shifting the first main set to a second main set in which the number of non-paired seats is smaller than a preset criterion; and changing and storing the performance direction data so that the first direction scene is performed in the second main set.

A system for checking a setting status of multiple light emitting devices according to another aspect of the disclosure may be linked to at least one kiosk providing a pairing service to a light emitting device; and an audience terminal, wherein a manager terminal may include at least one memory and at least one processor, and at least one application may be stored in a memory of a manager terminal, and executed by the processor to provide a performance setting service including acquiring pairing information for the multiple light emitting devices, displaying setting status information for a first performance according to the acquired pairing information on a setting status interface at a first time point, determining at least one target seat based on the setting status information for the first performance, transmitting a setting encouragement message based on the determined target seat, providing feedback content for the setting status information of the first performance at a second time point after transmitting the setting encouragement message, and changing and storing performance direction data matched with the first performance according to the provided feedback content.

### BRIEF DESCRIPTION OF THE DRAWINGS

FIG. 1 is a schematic conceptual diagram of a performance setting service providing system according to an embodiment of the disclosure.

FIG. 2 is a schematic block diagram of a terminal according to an embodiment of the disclosure.

FIG. 3 is a schematic block diagram of a kiosk according to an embodiment of the disclosure.

FIG. 4 is a schematic flowchart showing a method for checking a setting status of multiple light emitting devices according to an embodiment of the disclosure.

FIGS. 5 and 6 are schematic illustrative diagrams showing a setting status interface according to an embodiment of the disclosure.

FIG. 7 is a schematic illustrative diagram showing a direction scene included in performance direction data according to an embodiment of the disclosure.

FIG. 8 illustrates is an example of a setting encouragement message according to an embodiment of the disclosure.

FIG. 9 is a schematic illustrative diagram showing feedback content according to an embodiment of the disclosure.

FIG. 10 is a schematic illustrative diagram showing a method for changing seat-specific direction data according to an embodiment of the disclosure.

### DETAILED DESCRIPTION OF THE EMBODIMENTS

In the following description, for the purposes of explanation, numerous specific details are set forth in order to provide a thorough understanding of various embodiments or implementations of the disclosure. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in an embodiment.

Unless otherwise specified, the illustrated embodiments are to be understood as providing features of the disclosure. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the disclosure.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may represent different directions that are not perpendicular to one another. For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Throughout the specification, when an element is referred to as being “connected” to another element, the element may be “directly connected” to another element, or “electrically connected” to another element with one or more intervening elements interposed therebetween. The element may also be “connected by wire or wirelessly” to another element. Also, when an element is referred to as being “in contact” or “contacted” or the like to another element, the element may be in “electrical contact” or in “physical contact” with another element; or in “indirect contact” or in “direct contact” with another element.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

It will be understood that when an element such as a layer, film, region, or substrate is referred to as being “on” or “over” another element, it can be directly on the other element or intervening element(s) may also be present. In contrast, when an element is referred.

The term overlap may include layer, stack, face or facing, extending over, covering or partly covering or any other suitable term as would be appreciated and understood by those of ordinary skill in the art.

In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

The disclosure may be subjected to various transformations and may have various embodiments, and specific embodiments will be illustrated in the drawings and described in detail in the detailed description. The effects and characteristics of the disclosure and methods for achieving these will become clear from embodiments that will be described in detail later together with the drawings. However, the disclosure is not limited to the embodiments disclosed below, and can be implemented in various forms. In the following embodiments, terms such as first and second are used for the purpose of distinguishing one component from another component, rather than in a limiting sense. Further, singular expressions include plural expressions unless the context clearly indicates otherwise. Terms such as include or have mean the presence of characteristics or components described in the specification, and do not preclude a likelihood of one or more other characteristics or components being added. Further, in the drawings, sizes of the components may be exaggerated or reduced for the convenience of description. For example, since sizes and thicknesses of the respective components shown in the drawings are arbitrarily shown for the convenience of description, the disclosure is not necessarily limited to what is shown.

Hereinafter, embodiments of the disclosure will be described in detail with reference to the accompanying drawings, the same or corresponding components are denoted by the same drawing reference signs upon description with reference to the drawings, and redundant descriptions thereof will be omitted.

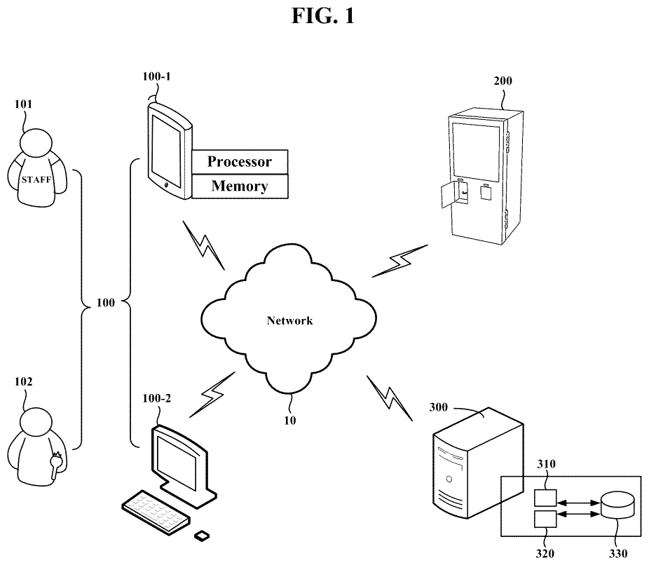

FIG. 1 is a schematic conceptual diagram of a performance setting service providing system according to an embodiment of the disclosure.

Referring to FIG. 1, a performance setting service providing system (hereinafter, a “service providing system”) according to an embodiment of the disclosure may provide a performance setting service for checking a setting status of multiple light emitting devices, which may indicate whether pairing has been performed on seat-specific direction data using a kiosk for a light emitting device and a terminal carried by an audience member seated in an auditorium (hereinafter, “performance setting service”).

In an embodiment, the performance setting service may be a service for managing pairing service that is performed in several kiosks installed in an auditorium.

In an embodiment, the pairing service may be a service for transmitting seat-specific direction data from a kiosk to multiple light emitting devices so that the light emitting devices can operate in an emission pattern according to a unified direction in an auditorium. In another embodiment, the pairing service may be a service for matching seat numbers of seats in which audience members will be seated with light emitting devices or audience terminals carried by the audience members and registering the matches in the kiosk.

Further, in an embodiment, the seat-specific direction data may be pre-stored using a kiosk or the like to the light emitting devices before the performance starts and may be stored differently depending on seats since audience members carrying the light emitting devices will be seated in different seats.

In an embodiment, the light emitting devices may download and store seat-specific direction data matched with each seat in advance and may emit light according to the pre-stored seat-specific direction data in response to a control signal of a repeater.

In another embodiment, the light emitting devices may be matched with a seat number of each set and may emit light differently for the matched seat number according to a seat-specific direction data reproduction signal included in a control signal of a repeater.

In an embodiment, the service providing system implementing the above-described performance setting service may be connected via a terminal 100, a kiosk 200, a performance management server 300, and a network 10.

Here, the network 10 according to the embodiment may be a connection structure that enables information exchange between respective nodes, such as the terminal 100, the kiosk 200, and/or the performance management server 300, and examples of such a network 10 may include, but are not limited to, a third generation partnership project network (3GPP), a long term evolution (LTE) network, a world interoperability for microwave access network (WIMAX), the Internet, a local area network (LAN), a wireless local area network (wireless LAN), a wide area network (WAN), a personal area network (PAN), a Bluetooth network, a satellite broadcasting network, an analog broadcasting network, a digital multimedia broadcasting (DMB) network, or the like.

Hereinafter, the terminal 100, the kiosk 200, and/or the performance management server 300 that implement the service providing system will be described in detail with reference to the accompanying drawings.

### Terminal 100

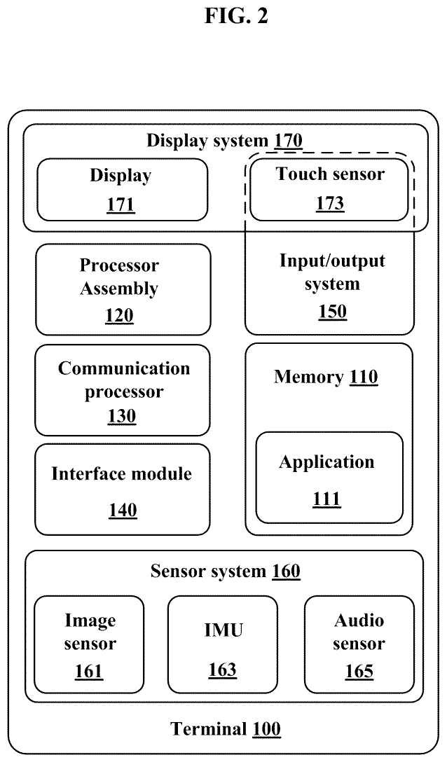

The terminal 100 according to an embodiment of the disclosure may be a predetermined computing device on which a performance setting application 111 shown in FIG. 2 (hereinafter, application) providing a performance setting service is installed.

Here, the application according to an embodiment may be divided into an application for a manager and/or an application for an audience member.

In this case, the application for a manager and the application for an audience member may be a single application but may be intended to perform different functional operations according to user entities.

For example, the application for a manager and the application for an audience member may be a single application but may be intended to function and operate with different authorities according to accounts of the manager and audience members.

Further, the application for a manager and the application for an audience member may be a performance platform that provides an Internet environment to set information necessary for a performance based on the performance setting service and to provide predetermined information based on the set information for the performance that the audience wishes to watch.

Further, in an embodiment, the terminal 100 on which such a performance management application is installed may include a manager terminal 101 that is used by the manager and an audience terminal 102 that is used by an audience member.

In an embodiment, the performance management application for a manager may be installed in the manager terminal 101, and the performance management application for audience may be installed in the audience terminal 102.

Here, the manager terminal 101 and/or the audience terminal 102 are used to distinguish users in the embodiment and may have the same components or functional operations.

Hereinafter, a case in which the manager terminal 101 and/or a guardian terminal are mobile computing devices will be described for convenience of description. Hereinafter, the term terminal 100 may be the manager terminal 101.

From a hardware perspective, the terminal 100 may include, for example, a mobile computing device 100-1 and/or a desktop computing device 100-2 in which the performance setting application 111 is installed.

Here, the mobile computing device 100-1 may be a mobile device such as a smart phone or tablet PC in which an application including the performance setting application 111 is installed.

For example, the mobile computing device 100-1 may include a smart phone, a mobile phone, a digital broadcasting device, a personal digital assistant (PDA), a portable multimedia player (PMP), a tablet PC, or the like.

Further, the desktop computing device 100-2 may include, for example, a device in which a program for executing the performance setting service based on wired or wireless communication is installed, such as a personal computer, for example, a fixed desktop PC, a laptop computer, or an Ultrabook in which the performance setting application 111 is installed.

Further, according to an embodiment, the terminal 100 may further include a predetermined server computing device that provides a performance setting service environment.

In the disclosure, the terminal 100 may be a large-capacity fixed server (for example, the performance management server 300), but is not particularly limited to any one form since the terminal 100 may also be a lightweight mobile server such as a smartphone or tablet.

Hereinafter, for convenience of description, a case in which the terminal 100 is implemented as the mobile computing device 100-1 will be described.

FIG. 2 is a schematic block diagram of the terminal 100 according to an embodiment of the disclosure.

Referring to FIG. 2, from a functional perspective, the terminal 100 may include the memory 110, a processor assembly 120, a communication processor 130, an interface module 140, an input and output system 150, a sensor system 160, and a display system 170. These components may be disposed in the terminal 100.

The performance setting application 111 may be stored in the memory 110 and may store one or more of various application programs, data, and instructions for providing the performance setting service environment.

For example, the memory 110 may store instructions and data that may be used to create the performance setting service environment.

Further, the memory 110 may include a program area and a data area.

Here, the program area according to an embodiment may be connected between an operating system (OS) that boots the terminal 100 and functional elements, and the data area may store data generated as the terminal 100 is used.

Further, the memory 110 may include at least one non-transitory computer-readable storage medium and a temporary computer-readable storage medium.

For example, the memory 110 may be any of various storage devices such as a Read-Only Memory (ROM), an Erasable Read-Only Memory (EPROM), a flash drive, or a hard drive, or may include a web storage that performs a storage function of the memory 110 on the Internet.

The processor assembly 120 may include at least one processor that can execute the instructions of the performance setting application 111 stored in the memory 110 to perform various tasks for creating the performance setting service environment.

In an embodiment, the processor assembly 120 may control an overall operation of the components through the performance setting application 111 of the memory 110 to provide the performance setting service.

The processor assembly 120 may be a system on chip (SOC) suitable for the terminal 100, which includes, for example, a central processing unit (CPU) and/or a graphic processing unit (GPU), may execute the operating system (OS) and/or application program stored in the memory 110, and may control each component mounted on the terminal 100.

Further, the processor assembly 120 may communicate with each component internally via a system bus and may include one or more predetermined bus structures including a local bus.

Further, the processor assembly 120 may be implemented to include at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

The communication processor 130 may include one or more devices for communication with external devices. The communication processor 130 may perform communication via a wireless network.

The communication processor 130 may communicate with the terminal 100 that stores a content source for implementing the performance setting service environment, and may communicate with various user input components such as a controller that receives user input.

In an embodiment, the communication processor 130 may transmit or receive various types of data related to the performance setting service to or from, for example, another terminal 100 and/or an external server.

This communication processor 130 may wirelessly transmit or receive data to or from at least one of a base station, an external terminal, and an arbitrary server on a mobile communication network constructed through a communication device capable of performing technical standards or communication schemes (for example, long term evolution (LTE), long term evolution-advanced (LTE-A), 5G New Radio (NR), or WIFI) for mobile communication, a short-range communication scheme (for example, RF, IR, NFC, or RFID), or the like.

The interface module 140 may communicatively connect the terminal 100 to one or more other devices. The interface module 140 may include a wired and/or wireless communication device that is compatible with one or more different communication protocols.

Through the interface module 140, the terminal 100 may be connected to various input and output devices.

For example, the interface module 140 may be connected to an audio output device such as a headset port or a speaker to output audio.

An example in which the audio output device is connected through the interface module 140 has been described, but in another embodiment, the audio output device may be installed inside the terminal 100.

Further, for example, the interface module 140 may be connected to an input device such as a keyboard and/or a mouse to acquire user input.

This interface module 140 may include at least one of a wired or wireless headset port, an external charger port, a wired or wireless data port, a memory card port, a port for connecting a device including an identification module, an audio input/output (I/O) port, a video input/output (I/O) port, an earphone port, a power amplifier, an RF circuit, a transceiver, and other communication circuits.

The input and output system 150 may detect a user's input related to the performance setting service (for example, a gesture, a voice instruction, an operation of a button, or another type of input).

Thus, the input and output system 150 may include a sensor system 160 and a display system 170.

The input and output system 150 may include, for example, a predetermined button, a touch sensor, and/or an image sensor that receives a user motion input.

Further, the input and output system 150 may be connected to an external controller through the interface module 140 to receive a user input.

Further, the input and output system 150 may receive a user input (for example, a touch input, a mouse input, a keyboard input, a gesture input, and a motion input using a guide tool).

For example, the terminal 100 may be connected to at least one device, such as a mouse, a keyboard, a gesture input controller, an image sensor (for example, a camera), or an audio sensor via the input and output system 150 according to various communication protocols, to acquire a user input.

Further, the terminal 100 may be connected to an external output device through the input and output system 150 and may be connected to, for example, a display system 170, an audio output device, or the like to output predetermined data.

The sensor system 160 may include various sensors such as an image sensor 161, a position sensor (IMU) 163, an audio sensor 165, a distance sensor, a proximity sensor, and a contact sensor.

Here, the image sensor 161 may capture an image and/or video of a physical space around the terminal 100.

In an embodiment, the image sensor 161 may capture and acquire various images and/or videos related to the performance setting service.

Further, the image sensor 161 may be disposed on the front surface and/or rear surface of the terminal 100 to capture a video in a direction in which the image sensor 161 is disposed and may film a physical space through a camera disposed to face the outside of the terminal 100.

The image sensor 161 may include an image sensor device and a video processing module. The image sensor 161 may process still images or moving images obtained by the image sensor device (for example, complementary metal oxide semiconductor sensor or charge-coupled device).

Further, the image sensor 161 may process the still images or moving images obtained by the image sensor device using an image recognition process (for example, Optical Character Recognition) and/or the video processing module to extract necessary information and transfer the extracted information to the processor.

The image sensor 161 may be a camera assembly including at least one camera. The camera assembly may include a general camera that films a visible light band and may further include a special camera such as an infrared camera or a stereo camera.

Further, the image sensor 161 as described above may be included and operated in the terminal 100 according to an embodiment or may be included in an external device (for example, an external server) and operated through linkage based on the communication processor 130 and/or the interface module 140 described above.

The audio sensor 165 may recognize sounds around the terminal 100.

The audio sensor 165 may include a microphone capable of detecting a voice input of a user using the terminal 100.

In an embodiment, the audio sensor 165 may receive voice data required for the performance setting service from the user.

The display system 170 may output various types of information related to the performance setting service as graphic images.

In an embodiment, the display system 170 may display various user interfaces for a performance setting service (for example, a setting status interface and/or a target seat determination interface).

Such a display may include at least one of a liquid crystal display (LCD), a thin film transistor-liquid crystal display (TFT LCD), an organic light emitting diode (OLED), a flexible display, a 3D display, and an e-ink display.

The above components may be disposed in the terminal 100, and the user interface may include a touch sensor 173 on a display 171 to receive a user touch input.

The display system 170 may include the display 171 that outputs an image and the touch sensor 173 that detects a user's touch input.

For example, the display 171 may be implemented as a touch screen by forming a mutual layer structure with the touch sensor 173 or by being integrally formed with the touch sensor 173. Such a touch screen may function as a user input unit that provides an input interface between the terminal 100 and the user and may provide an output interface between the terminal 100 and the user.

The terminal 100 including the above-described components may store at least one of pairing information, setting status information, performance information, pairing proportion, seat layout, target seat, seat-specific direction data, performance direction data, setting encouragement message, and/or feedback content in the memory 110 according to an embodiment.

Further, in an embodiment, the terminal 100 may acquire the pairing information for the multiple light emitting devices based on the performance setting application 111.

Further, in an embodiment, the terminal 100 may display the setting status information for the performance according to the pairing information acquired through a setting status providing interface.

Further, in an embodiment, the terminal 100 may determine at least one target seat based on the setting status information.

Further, in an embodiment, the terminal 100 may perform a control so that the setting encouragement message is transmitted based on the determined target seat.

Further, in an embodiment, the terminal 100 may be connected with a predetermined light emitting device.

In an embodiment of the disclosure, a light emitting device may be a predetermined device that emits light according to the seat-specific direction data including setting values such as brightness, saturation, and effect received from the terminal 100 and/or the kiosk 200 based on the performance setting service.

The light emitting device includes a light emitting unit and multiple light emitting diodes included in the light emitting unit may be arranged in a dot form and selectively turned on under the control of the processor so that a specific phrase (text), image, or video can be displayed.

Although an example in which a light source of the light emitting unit is a light emitting diode (LED) has been described, a type of light source is not limited to the LED. According to another embodiment, an organic light emitting diode (OLED) may be used as the light source.

Further, in the embodiment, the light emitting device may include a wireless communication module (for example, at least one of NFC, RF transmitter/receiver, Zigbee, Bluetooth, and WIFI modules) to transmit or receive various types of data related to the performance setting service to or from another terminal and/or an external server.

Further, in an embodiment, the light emitting device may operate according to an emission pattern control signal included in the seat-specific direction data received from the kiosk 200.

Further, in the embodiment, the light emitting device may also operate according to an emission pattern control signal received in real time through a repeater or the like on site.

Further, in the embodiment, the light emitting device may store information (for example, seat-specific direction data) necessary for performing the performance setting service.

Although a case in which the terminal 100 according to the embodiment of the disclosure performs the functional operation has been described above, various other embodiments may be possible. For example, at least a part of the functional operation performed by the terminal 100 may be performed by an external device (for example, the service providing server) according to an embodiment, or at least a part of a functional operation performed by the external device may be further performed by the terminal 100, the kiosk 200, and/or the performance management server 300.

### Kiosk 200

The kiosk 200 according to the embodiment of the disclosure may be a predetermined computing device that transmits seat-specific direction data to a predetermined light emitting device in order to provide a performance setting service.

In an embodiment of the disclosure, an example in which the predetermined computing device that provides a performance setting service is implemented as the kiosk 200 will be described, but the computing device may also be implemented through a mobile computing device (for example, a tablet or a smartphone) and/or a desktop computing device (for example, a PC), and peripheral devices connected thereto.

Further, the kiosk 200 according to an embodiment of the disclosure may include a master kiosk and/or a slave kiosk.

Here, the master kiosk according to an embodiment may be a kiosk that controls other devices including one or more slave kiosks and processes and acts as a communication hub. Further, the slave kiosk according to an embodiment may be a kiosk that provides a pairing service for a light emitting device under the control of the master kiosk.

In an embodiment, the master kiosk may store a performance setting program for controlling at least one slave kiosk, and the slave kiosk may store a pairing program.

Accordingly, the master kiosk may transmit the seat-specific direction data generated according to the performance setting service to at least one slave kiosk, and the slave kiosk may provide the pairing service under the control of the master kiosk.

Further, in the embodiment, the kiosk 200 may further include a predetermined server computing device that provides a pairing service environment.

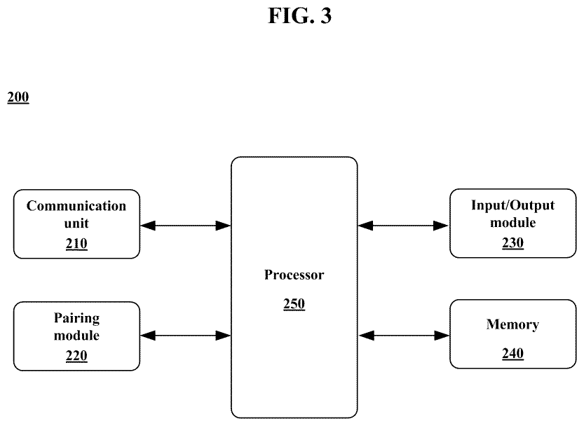

FIG. 3 is a schematic block diagram of the kiosk according to an embodiment of the disclosure.

Referring to FIG. 3, from a functional perspective, the kiosk 200 may include a communication unit 210, a pairing module 220, an input and output module 230, a memory 240, and a processor 250.

The kiosk 200 according to an embodiment may be implemented as an online type and/or an offline type depending on whether or not the communication unit 210 is included.

In an embodiment, when the kiosk 200 is implemented as the online type, the kiosk 200 may communicate with the performance management server 300 in real time to transmit and receive predetermined information to and from the performance management server 300.

In an embodiment, the kiosk 200 may use a first communication scheme in which only the master kiosk communicates with the performance management server 300 to receive predetermined information and transmits the received predetermined information to at least one slave kiosk.

Further, in an embodiment, the kiosk 200 may use a second communication scheme in which the master kiosk simply performs a hotspot function, and the master kiosk and/or the at least one slave kiosk all communicate with the performance management server 300 to transmit and receive predetermined information.

Further, in another embodiment, when the kiosk 200 is implemented as the offline type, the master kiosk may acquire and pre-store the latest performance information (for example, seat-specific direction data) in advance from the performance management server 300 in a stable Internet environment, and transmit the pre-stored performance information to at least one slave kiosk without electrical communication with the performance management server 300 in an area in which the Internet environment is unstable.

In this case, the master kiosk may form an independent wireless network with each slave kiosk as an access point (AP) and transmit predetermined information.

The communication unit 210 may include one or more devices for communication with external devices. This communication unit 210 may perform communication via a wireless or wired network.

The communication unit 210 may communicate with the performance management server 300 that stores content sources for providing the performance setting service and may communicate with various user input components such as a controller that receives user input.

In an embodiment, the communication unit 210 may transmit or receive various types of data related to the performance setting service to and from, for example, other terminals and/or external servers.

The communication unit 210 may wirelessly transmit or receive data to or from at least one of a base station, an external terminal, and an arbitrary server on a mobile communication network constructed through a communication device capable of performing technical standards or communication schemes (for example, long term evolution (LTE), long term evolution-advanced (LTE-A), 5G New Radio (NR), and WIFI) for mobile communication, or the like, and may also perform communication through a wired connection.

In an embodiment, the communication unit 210 may receive performance preparation information including the seat-specific direction data and performance-related detailed information in real time from the performance management server 300.

For example, when the kiosk 200 including the communication unit 210 is implemented as an online type, the kiosk 200 acquires changed performance information in real time, thereby allowing a user receiving a light emitting device pairing service of the slave kiosk to stably acquire the latest information immediately even when performance information changes suddenly.

The pairing module 220 may include a short-range communication processor for detecting the light emitting device.

The pairing module 220 may detect whether a tagged, mounted, and/or settled light emitting device is approaching and communicate with the light emitting device to transmit and receive data upon the detection.

For example, the pairing module 220 may include a communication chip that performs short-range communication (for example, Radio Frequency Identification (RFID), Near Field Communication (NFC), Magnetic Secure Transmission (MST), Near Field Magnetic Induction (NFMI), or Bluetooth communication).

Further, the pairing module 220 may transmit and receive various types of data related to the pairing service (for example, seat-specific direction data) to and from an external device via short-range communication.

In an embodiment, when the pairing module 220 recognizes that the light emitting device is located within a predetermined distance, the pairing module 220 may perform short-range communication with the light emitting device to transmit and receive various types of data for receiving seat-specific direction data.

The pairing module 220 may include a predetermined support member in order to stably fix the light emitting device located within the predetermined distance in terms of hardware.

For example, the predetermined support member may be implemented in a mounting form for mounting the light emitting device, a form of a pad for placement of the light emitting device or a form of a box having an internal space for accommodating the light emitting device.

The input and output module 230 may include a sensor system, an input system, and a display system. Since the content of the input and output module 230 is the same as that described in the input and output system 150 of the terminal 100, only differences therebetween will be described.

In an embodiment, a camera of the input and output module 230 may capture and acquire images related to the pairing service (for example, a paper ticket image and/or a mobile ticket image).

In an embodiment, a display system of the input and output module 230 may display, for example, a user interface (UI), content related to pairing, and/or content management system (CMS)-based data.

The memory 240 may store one or more of various application programs, data, and instructions for providing the performance setting service environment.

In the embodiment, the memory 240 may store an application including an instruction for controlling the kiosk 200. Since the description of the memory 240 is the same as that of the memory 110 of the terminal 100, the description will be omitted.

The kiosk 200 according to an embodiment including the above-described configurations may provide the pairing service for transmitting the seat-specific direction data corresponding to each seat to be arranged at the time of a performance to the light emitting device that stores the seat-specific direction data in advance.

The master kiosk may transmit predetermined performance information for providing the pairing service to multiple connected slave kiosks, and the slave kiosks may perform pairing on multiple light emitting devices based on the received performance information.

In the embodiment, the slave kiosk may perform pairing on the light emitting device located within a predetermined distance that has been preset, such as tagging at and/or mounting on the slave kiosk.

Further, in the embodiment, the slave kiosk may transmit seat-specific direction data to the paired light emitting device.

Further, in the embodiment, the master kiosk may generate pairing information acquired by calculating the number of pairings performed in each connected slave kiosk.

Further, in the embodiment, the master kiosk may transmit the generated pairing information to the terminal 100.

### Performance Management Server 300

The performance management server 300 according to the embodiment of the disclosure may perform a series of processes for providing the performance setting service.

In an embodiment, the performance management server 300 may be a central management device that controls the terminal 100 and/or the kiosk 200 and may be implemented as a predetermined computing device.

In an embodiment, the performance management server 300 may provide the performance setting service by exchanging with the external device data necessary for a performance setting process to be driven in an external device such as the kiosk 200.

In an embodiment, the performance management server 300 may provide an environment in which multiple applications installed in multiple devices performing the performance setting service can operate in the external device.

Thus, the performance management server 300 may include application programs, data, and/or instructions for operation of applications and may transmit and receive data based on these to and from the external device.

The performance management server 300 may provide the performance setting service based on the performance setting program for providing the performance setting service.

In an embodiment, the performance management server 300 may generate and/or acquire performance information that is a target of the performance setting service.

Further, in an embodiment, the performance management server 300 may transmit the performance information to the kiosk 200.

Further, in an embodiment, the performance management server 300 may comprehensively control at least one connected master kiosk.

Further, in an embodiment, the performance management server 300 may acquire predetermined data collected according to pairing performed in at least one kiosk.

Further, in an embodiment, the performance management server 300 may extract seat information matched with the terminal (for example, the audience terminal 102) and/or the light emitting device on which the pairing has been performed.

Further, the seat information may include at least one of a seat number and/or a pixel number.

In an embodiment, the seat information is exposed to the user as a seat number actually used in the auditorium, for example, in a format of “zone 12, row A, number 1 on third floor,” but may be exposed as a pixel number based on the seat layout for convenience of the direction in the manager terminal 101 that performs a direction or the like according to an emission pattern.

For example, the performance management server 300 may convert the seat-specific direction data created as a pixel number on a performance director's device or the like into a seat number when transmitting the seat-specific direction data to the kiosk 200. Thus, the pixel number and the seat number may be associated with each other in advance.

Further, in an embodiment, the performance management server 300 may store and manage multiple seat-specific direction data generated for respective seat information in the database 330.

Further, in an embodiment, the performance management server 300 may store and manage, for example, various application programs, instructions, and/or data for implementing the performance setting service and/or the pairing service.

Referring back to FIG. 1, in an embodiment, the performance management server 300 as described above may be implemented as a predetermined computing device including at least one processor module 310 for data processing, at least one communication module 320 for data exchange with an external device, and at least one memory module 330 for storing various application programs, data, and/or instructions for providing the performance setting service.

Here, the memory module 330 may store any one or more of an operating system (OS), various application programs, data, and instructions for providing the performance setting service.

Further, the memory module 330 may include a program area and a data area.

Here, the program area according to the embodiment may be connected between an operating system (OS) that boots the server and functional elements, and the data area may store data generated as the server is used.

In an embodiment, the memory module 330 may be any of various storage devices such as a ROM, a Random Access Memory (RAM), an EPROM, a flash drive, and a hard drive, and may also be a web storage that performs a storage function of the memory module 330 on the Internet.

Further, the memory module 330 may be a removable storage medium on the server.

Meanwhile, the processor module 310 may control overall operation of each unit described above in order to implement the performance setting service.

The processor module 310 may be a system on chip (SOC) suitable for a server including, for example, a central processing unit (CPU) and/or a graphics processing unit (GPU), and may execute, for example, an operating system (OS) and/or application program stored in the database 330 and control each component of the server.

Further, the processor module 310 may communicate with each component internally through a system bus and may include one or more predetermined bus structures, including a local bus.

Further, the processor module 310 may be implemented by at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

Although a case in which the performance management server 300 according to an embodiment of the disclosure performs the functional operation has been described above, various other embodiments may be possible. For example, at least a part of the functional operation performed by the performance management server 300 may be performed by an external device (for example, the kiosk 200) according to the embodiment, and at least a part of a functional operation performed by the external device may be further performed by the performance management server 300.

### Method for Checking Setting Status of Multiple Light Emitting Devices

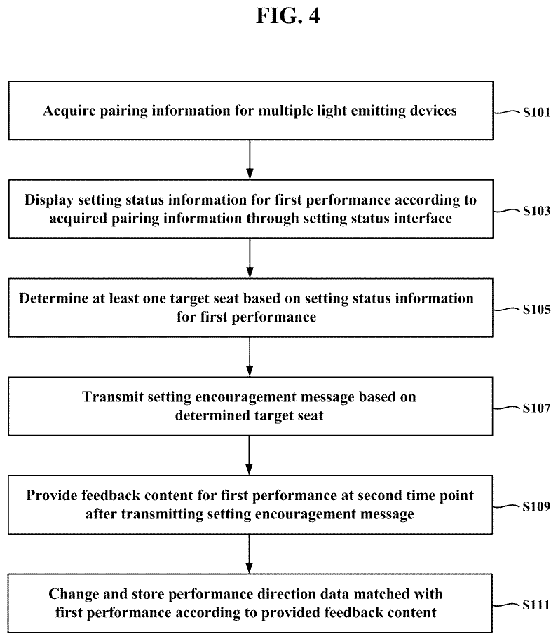

Hereinafter, a method for checking a setting status of multiple light emitting devices in a processor, which is executed by at least one processor of the terminal 100 (for example, the manager terminal 101) according to an embodiment of the disclosure will be described in detail with references to FIGS. 4 to 10.

In order for the terminal 100 to perform a method for checking a setting status of multiple light emitting devices based on the processor assembly 120, at least one processor of the terminal 100 may execute at least one performance setting application 111 stored in at least one memory 110 or cause the performance setting application 111 to operate in a background state in an embodiment of the disclosure.

Hereinafter, a case in which the performance setting application 111 supports the terminal 100 described above performing the method for checking a setting status of multiple light emitting devices by the at least one processor of the terminal 100 operating to execute the instructions of the memory 110 will be described.

Further, a case in which the performance setting application 111 performs the method for checking a setting status of multiple light emitting devices described above by the at least one processor of the terminal 100 operating to execute the instructions of the processor assembly 120 will be described.

FIG. 4 is a flowchart showing the method for checking a setting status of multiple light emitting devices according to an embodiment of the disclosure.

Referring to FIG. 4, in an embodiment, the performance setting application 111 may acquire the pairing information for the multiple light emitting devices (S101).

In an embodiment, the performance setting application 111 may receive and acquire the pairing information for the multiple light emitting devices from the master kiosk.

In an embodiment, the pairing information may be information including the number of the multiple light emitting devices that have been paired to the kiosk 200 and have downloaded the seat-specific direction data. Further, the pairing information may include seat information (for example, seat numbers) matched with the audience terminal 102 and/or the light emitting device that have received the seat-specific direction data through pairing.

Thus, multiple slave kiosks according to the embodiment may perform the pairing with the multiple light emitting devices.

In an embodiment, the pairing may be an entire action of the audience members using the kiosk to download the seat-specific direction data to the multiple light emitting devices so that the multiple light emitting devices can operate in an emission pattern according to a unified direction in an auditorium.

Further, the master kiosk according to an embodiment may acquire the pairing information from each slave kiosk on which the pairing has been performed at least once.

Further, the master kiosk according to an embodiment may transmit the acquired pairing information to the terminal 100 in real time, so that the performance setting application 111 according to the embodiment can acquire the pairing information of the multiple light emitting devices.

For example, in an embodiment, the performance setting application 111 may acquire the pairing information in real time from at least one master kiosk.

Further, in an embodiment, the performance setting application 111 may display setting status information for the first performance according to the acquired pairing information on the setting status interface (S103).

The setting status interface according to the embodiment may be an interface for indicating and managing setting status information based on the seat layout of the auditorium including status of the pairing and the pairing proportion for a performance to be provided at the auditorium.

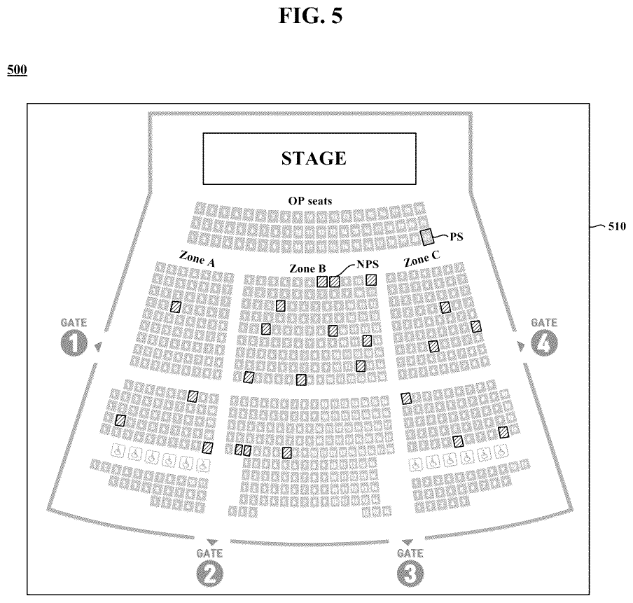

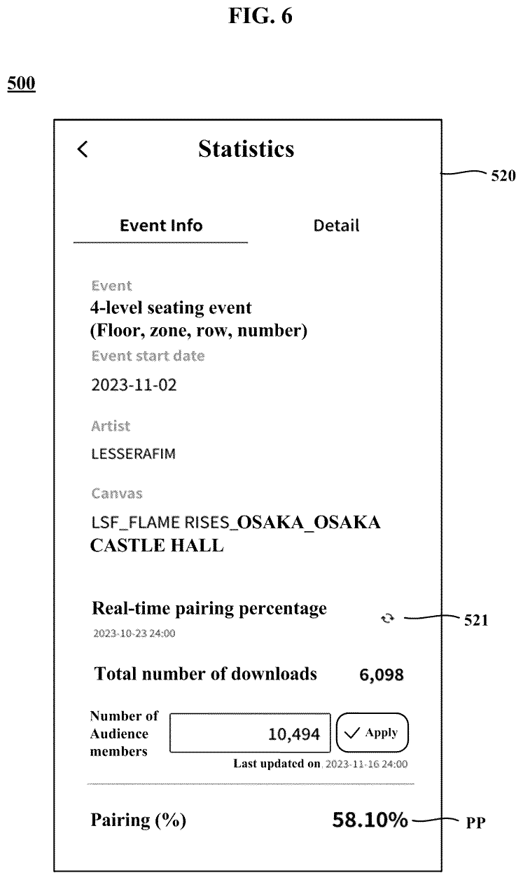

FIGS. 5 and 6 are schematic illustrative diagrams showing the setting status interface according to an embodiment of the disclosure. FIG. 5 illustrates an example of the setting status interface in which the seat layout in the setting status information is indicated, and FIG. 6 illustrates an example of the setting status interface in which performance information is indicated.

Referring to FIGS. 5 and 6, in the embodiment, the performance setting application 111 may display the setting status information for the first performance at the first time point on a setting status interface 500.

In an embodiment, the setting status information may include a seat layout 510 indicating at least one paired seat PS and non-paired seat NPS for the first performance, and/or the performance information 520 indicating a pairing proportion PP.

The seat layout 510 may be content including an image showing a form in which seats are laid out in an auditorium where a performance takes place. The seat layout 510 may display at least one seat.

In this case, in the embodiment, the performance setting application 111 may display a seat for which pairing has been completed as the paired seat PS, and a seat for which pairing has not been completed as the non-paired seat NPS according to the acquired pairing information.

The performance information 520 may be overall information required to execute the performance setting service, which is content indicating information on an ongoing performance in text format.

The performance information 520 may include at least one of connection server information, device setting information, pop-up information, pairing statistics information, firmware information, and preset information. Further, the performance information may further include performance preparation information including a performance name, artist name, performance time, and performance place for a performance corresponding to the seat-specific direction data to be provided to the multiple light emitting devices for pairing service, user account information for identifying users, ticket reservation information, and/or seat information. The above-described configurations included in the performance information 520 may not be illustrated, and the performance information is not limited to the above and may include various types of information on the performance.

Referring to FIG. 6, as an example, the performance information 520 may include performance date and time, performance artist, performance place, pairing proportion, the number of paired seats, the number of non-paired seats, and/or a pairing seat list.

Here, the pairing proportion PP according to the embodiment may be information indicating, as a value, the number of paired seats PS in relation to the number of audience members for the performance based on the pairing information performed in each slave kiosk.

For example, when the number of audience members is about 10,494 and the number of paired seats PS (for example, the number of seat-specific direction data downloads) is about 6,098, the pairing proportion PP may be calculated as about 58.10%. Further, the calculated pairing proportion PP may be displayed as the performance information 520.

In order to calculate this pairing proportion PP, the performance setting application 111 in the embodiment may acquire information including the number of audience members for the first performance by linking with an external terminal, an external server, and/or a performance management server 300. In this case, the number of audience members may correspond to the number of seats sold and/or ticketing completed.

Further, in another embodiment, the performance setting application 111 may determine the number of audience members by the number of audience members being manually input or automatically input through an automatic process of providing the number of seats included in an auditorium by default when the performance place is selected.

Further, in an embodiment, the performance setting application 111 may change the setting status information for the first performance according to the pairing information acquired in real time when an input to a refresh button 521 is detected.

Accordingly, in an embodiment, the performance setting application 111 may update the paired seats PS and/or the pairing proportion PP indicated on the setting status interface 500 and provide the paired seats PS and/or the pairing proportion PP to the manager.

In this case, the performance director (or manager) may statistically check how many audience members have performed the pairing before the start of the performance. Further, the performance director (or manager) may check setting status of an area in which the pairing should be essentially performed for performance direction. Here, when the pairing proportion of the area is equal to or lower than a preset criterion, a predetermined notification may be provided to encourage the pairing for the seats included in the area.

To this end, in an embodiment, the performance setting application 111 may determine at least one target seat based on the setting status information for the first performance (S105).

In an embodiment, the performance setting application 111 may determine at least one target seat included in an area in which pairing should be performed according to the setting status information for the first performance (hereinafter, a target area).

In an embodiment, the performance setting application 111 may determine the target seat according to the performance director (or manager) input for manually selecting at least one non-paired seat NPS.

Further, in an embodiment, the performance setting application 111 may also determine the target seat according to an automated target seat determination process.

Thus, in an embodiment, the performance setting application 111 may acquire the seat-specific direction data from an external terminal and/or an external server.

Further, in an embodiment, the performance setting application 111 may identify an emission time and/or non-emission time included in the seat-specific direction data matched with each seat.

For example, the performance setting application 111 in the embodiment may filter seats matched with the seat-specific direction data that includes an emission time longer than a preset criterion.

Further, in an embodiment, the performance setting application 111 may classify non-paired seats NPS for which pairing has not been performed among the filtered seats.

Accordingly, in the embodiment, the performance setting application 111 may determine that the classified non-paired seats NPS are target seats.

Further, in the embodiment, the performance setting application 111 may determine the target seats based on the performance direction data acquired from the external terminal and/or an external server.

Here, the performance direction data according to the embodiment may be data with various predefined emission patterns in which the light emitting devices should emit light at the respective seats, for a unified performance direction before the performance. For example, in an embodiment, performance direction data corresponding to one seat in which the light emitting device is to be disposed is the seat-specific direction data.

Further, the performance setting application 111 in the embodiment may determine a first direction scene from the acquired performance direction data.

Here, the first direction scene may be a scene including an emission pattern in an important direction section determined by a performance director (or manager) in the performance direction data.

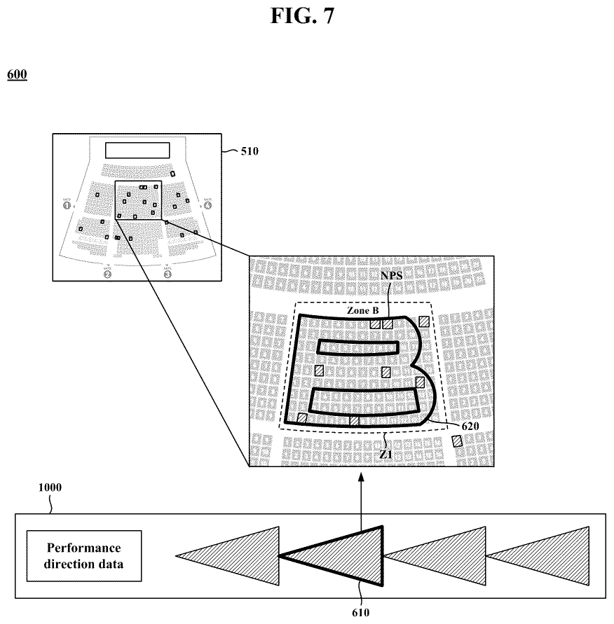

Further, in an embodiment, the performance setting application 111 may display the determined first direction scene based on the seat layout 510 in a target seat determination interface 600 of FIG. 7.

FIG. 7 is a schematic illustrative diagram showing a direction scene included in performance direction data 1000 according to an embodiment of the disclosure.

Referring to FIG. 7, in an embodiment, the performance setting application 111 may determine a first direction scene 610 in the performance direction data 1000 on the target seat determination interface 600.

In the embodiment, the first direction scene 610 may be a part of the direction that the performance director (or manager) has determined to be important, which is a part of the performance direction data in which predetermined light pattern information has been preset.

For example, in the embodiment, the performance setting application 111 may reflect emission pattern information 620 in the seat layout 510 to display the emission pattern information 620 so that the performance director (or manager) can visually check the first direction scene 610 and determine the target seat.

Further, in the embodiment, the performance setting application 111 may reflect the emission pattern information 620 included in the first direction scene 610 on the seat layout 510 to display the emission pattern information 620.

Further, the displayed first direction scene 610 may include a first main set Z1. In this case, the first main set Z1 may include seats at which an important direction determined by the performance director (or manager) is performed in the first direction scene.

For example, the first main set Z1 included in the first direction scene 610 illustrated in FIG. 7 may include a first emission set included in a letter area called “B” and a second emission set not included in the letter area called “B”.

Further, in an embodiment, the performance setting application 111 may classify the non-paired seat NPS in the determined first main set Z1.

Further, in an embodiment, the performance setting application 111 may determine that the classified non-paired seat NPS is a target seat.

In this case, in the embodiment, the performance setting application 111 may shift the first main set Z1 to another zone when the number of non-paired seats NPS classified from the first main set Z1 is equal to or greater than a preset criterion. This will be described in detail later.

Further, in an embodiment, the performance setting application 111 may transmit the setting encouragement message based on the determined target seat (S107).

Here, the setting encouragement message according to the embodiment may be a message for encouraging pairing of seat-specific direction data for the performance to the light emitting device.

The types of transmitting such setting encouragement message may be divided into a basic type and/or a special type.

The basic type may be a type of transmitting the setting encouragement message to all audience terminals 102 carried by multiple audience members attending the performance.

The special type may be a type of transmitting the setting encouragement message only to the audience terminals 102 of the audience members seated in the target seats among the multiple audience members attending the performance.

When the setting encouragement message is transmitted as the special type, personal information and/or seat information may be collected, and the setting encouragement message may be transmitted based on the collected information. In this case, when the personal information cannot be collected due to personal information protection, the setting encouragement message may be targeted and transmitted based only on the seat information.

For example, in an embodiment, the performance setting application 111 may transmit the setting encouragement message according to at least one of the basic type and/or the special type.

Further, in an embodiment, the performance setting application 111 may insert information on the determined target seat into the setting encouragement message.

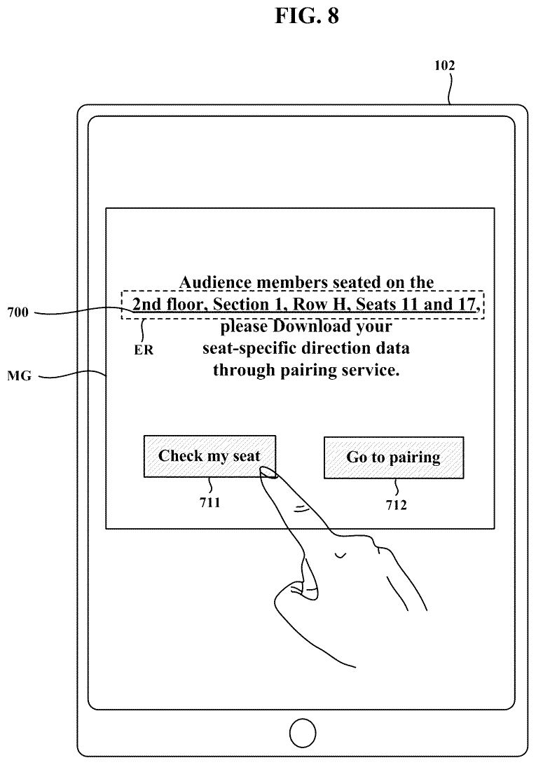

FIG. 8 illustrates an example of a setting encouragement message according to an embodiment of the disclosure.

Referring to FIG. 8, in the embodiment, the application 111 may generate and transmit a setting encouragement message MG including a record ER.

In an embodiment, the setting encouragement message MG may include the record ER so that a predetermined text and/or button is set as a basic form.

In this case, in an embodiment, the performance setting application 111 may input a target seat 700 in the empty record ER to generate the setting encouragement message MG.

When the setting encouragement message MG is generated on the target seat determination interface 600 of the manager terminal 101, the manager terminal 101 may transmit the setting encouragement message MG to at least one audience terminal 102.

In the performance setting application 111 of the audience terminal 102 that has received the setting encouragement message MG, the generated setting encouragement message MG as illustrated in FIG. 8 may be indicated.

In an embodiment, the target seat 700 input in the setting encouragement message MG may be indicated to include at least one of a floor, row number, row number, and zone number in which the auditorium seats are located.

Further, the setting encouragement message MG displayed on the audience terminal 102 in the embodiment may include at least one or more buttons 711 and 712. When an input to at least one of the buttons 711 and 712 is detected, the performance setting application 111 of the audience terminal 102 may provide a predetermined guide (for example, a pairing guide) that supports performing a pairing service.

For example, when an input to a first button 711 is detected, the performance setting application 111 may automatically execute a seat confirmation process. The seat confirmation process may be a process of comparing an audience's seat with the target seat 700 included in the record ER. According to the process, a pop-up may be displayed to guide whether the target seat 700 and the audience's seat match.

In this case, when the target seat 700 and the audience's seat do not match, or when the audience has already downloaded the seat-specific direction data, the pop-up may be terminated.

On the other hand, when the target seat 700 and the audience's seat match or an input to a second button 712 that provides a “Go to pairing” link is detected, the application 111 may provide a predetermined guide for supporting performing a pairing service for pairing the seat-specific direction data to the light emitting device. For example, a guidance to a kiosk location and/or a pairing method may be provided as a pairing guide based on the interface of the audience terminal 102.

For example, in the embodiment, the performance setting application 111 may automatically input the determined target seat 700 to the record ER of the setting encouragement message MG, thereby generating and transmitting the setting encouragement message MG.

Further, in the embodiment, the performance setting application 111 may provide feedback content for the first performance at a second time point after transmitting the setting encouragement message (S109).

The second time point may be a time point later than the first time point at which the setting status information is first provided.

Further, the feedback content according to the embodiment may include information indicating a change in the pairing proportion before and after the setting encouragement message is transmitted.

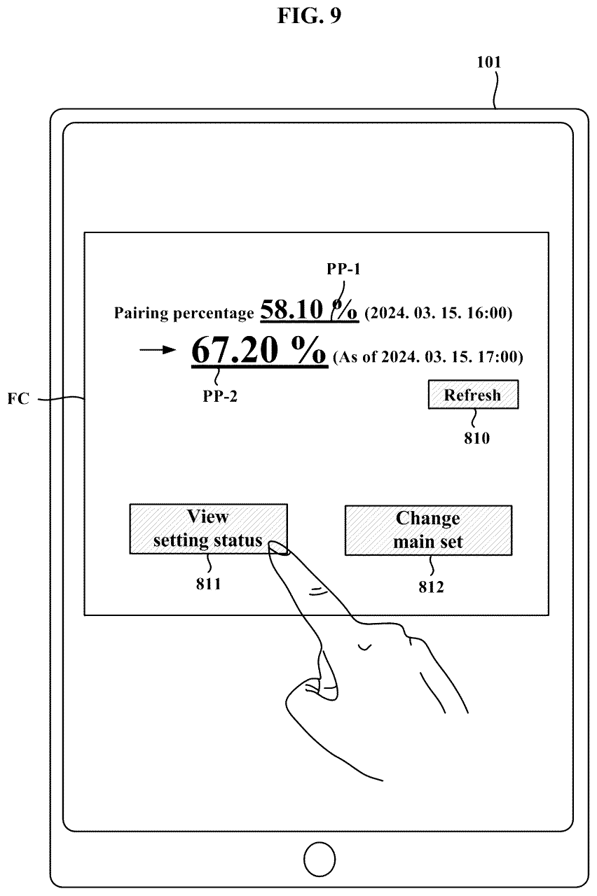

FIG. 9 is a schematic illustrative diagram showing feedback content according to the embodiment of the disclosure.

Referring to FIG. 9, the performance setting application 111 of the manager terminal 101 according to the embodiment may provide feedback content FC indicating a first pairing proportion PP-1 at a first time point and a second pairing proportion PP-2 at a second time point.

In an embodiment, the feedback content FC may display the first pairing proportion PP-1 and/or the second pairing proportion PP-2. In this case, the first pairing proportion PP-1 may be displayed together with the exact date and time at which the pairing proportion was calculated. Further, the second pairing proportion PP-1 may be displayed together with a current date and time.

In this case, in an embodiment, when the performance setting application 111 detects an input to a refresh button 810 included in the feedback content FC, the application 111 may update and display the second pairing proportion PP-2 and a current date and time when the second pairing proportion PP-2 has been newly calculated.

Further, in an embodiment, when the performance setting application 111 detects an input to a setting status view button 811, the application 111 may display the seat layout 510 indicating the paired seats PS and the non-paired seats NPS and/or the performance information 520 on the setting status interface 500.

Further, in an embodiment, when the performance setting application 111 detects an input to a main set change button 812, the application 111 may provide the target seat determination interface 600 for shifting the first main set Z1 to another zone for the first direction scene.

In this case, the input to the main set change button 812 may be automatically or manually activated when the second pairing proportion PP-2 is equal to or smaller than a preset reference value and/or depending on an autonomous determination of the performance director (or manager).

Further, in the embodiment, the performance setting application 111 may change and store the performance direction data 1000 matched with the first performance according to the provided feedback content FC (S111).

Specifically, in an embodiment, the performance setting application 111 may change and store the seat-specific direction data by shifting the first main set Z1 for the first direction scene 610 to another zone in the seat-specific direction data matched with the first performance according to the provided feedback content FC on the target seat determination interface 600.

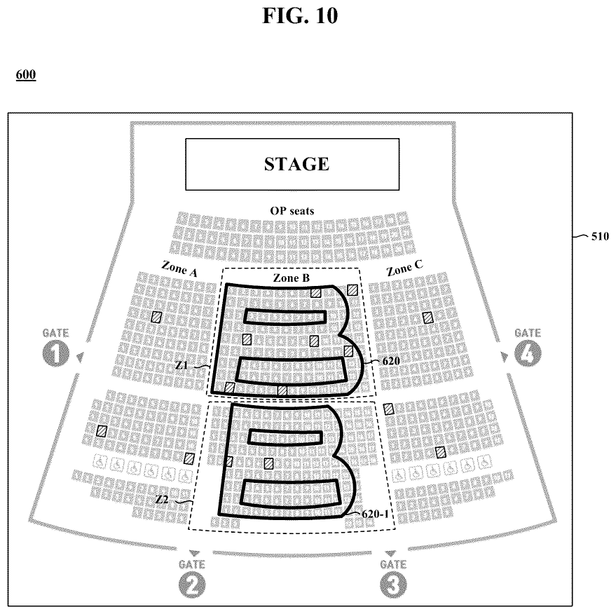

FIG. 10 is a schematic illustrative diagram showing a method for changing seat-specific direction data according to an embodiment of the disclosure.

Referring to FIG. 10, in the embodiment, the performance setting application 111 may change from the first main set Z1 to a second main set Z2 for the first direction scene in the performance direction data.

The second main set Z2 may be a zone where the number of non-paired seats NPS is less than a preset criterion and the first direction scene is directed. In other words, the second main set Z2 may be a changed zone because it is determined that the first direction scene cannot be directed in the first main set Z1 where the number of non-paired seats NPS is equal to or greater than the preset criterion.

In this case, in an embodiment, the performance setting application 111 may determine second emission pattern information 620-1 of the second main set Z2 by changing a size, position, and/or shape of first emission pattern information 620 included in the first main set Z1.

The light emitting devices located in the second main set Z2 shifted and determined in this way may emit light according to the seat-specific direction data in the first direction scene, instead of the light emitting devices located in the first main set Z1.

In another embodiment, the performance setting application 111 may delete the seat-specific direction data for a first section including the first direction scene from the performance direction data and set the light emitting devices located in the auditorium to emit light in response to a control signal of the repeater in the deleted first section.

Thus, in another embodiment, the performance setting application 111 may set the deleted first section to a mode for emitting light according to the control signal of the repeater, thereby controlling the light emitting devices to emit light.

Further, in another embodiment, the performance setting application 111 may determine that an emission target zone is the second main set Z2 according to the control signal of the repeater in the first section.

In this case, the control signal of the repeater provided to the light emitting devices in the first section may include a seat-specific direction data reproduction signal for causing the light emitting devices located in the second main set Z2 to emit light.

For example, in another embodiment, the performance setting application 111 may delete the first section including the first direction scene in which the light emitting devices located in the first main set Z1 emit light according to existing seat-specific direction data, and change the first section to a mode in which light is emitted according to the control signal of the repeater, thereby determining that the light emitting devices located in the second main set Z2 emit light in the first section.

Accordingly, the disclosure has the effect of enabling flexible response to the performance direction by shifting the main set to another zone when it is expected that the light emitting devices will not emit light as intended due to a low pairing proportion in the main set in which the light emitting devices should emit light a preset criterion or more in the important direction section, and allowing an originally planned direction scene to be used as is with only a certain position changed.

As described above, with the method and the system for checking a setting status of multiple light emitting devices according to the embodiment of the disclosure, it is possible to provide setting status information indicating whether a light emitting device and an audience terminal located at each seat have completed pairing for operating with seat-specific direction data in a performance, thereby greatly reducing human and time resources required to collect the kiosks and directly collect the number of pairings.

Further, the method and the system for checking a setting status of multiple light emitting devices according to an embodiment of the disclosure has the effect of increasing the satisfaction of artists and audiences regarding the performance by transmitting the setting encouragement message to seats in which pairing is essentially required to enable a unified direction using light emitting devices.

Further, with the method and the system for checking a setting status of multiple light emitting devices according to an embodiment of the disclosure, it is possible to check the number of people performing pairing relative to the number of people watching the performance in real time by collecting and monitoring a real-time pairing proportion for each kiosk, to reduce the need for the manager to manually check an auditorium while continuously walking around the auditorium, and immediately respond to a kiosk error, thereby ensuring the ease of on-site monitoring.

Further, with the method and the system for checking a setting status of multiple light emitting devices according to an embodiment of the disclosure, it is possible to increase flexibility in event setting and operating by shifting a target zone for operation with seat-specific direction data to a predetermined zone according to the setting status to change a direction zone to a zone in which an intended direction is highly likely to be realized.

However, the effects of the disclosure are not limited to the effects mentioned above, and other effects not mentioned may be clearly understood from the detailed description.

The embodiment of the disclosure described above may be implemented in the form of program instructions that can be executed through various computer components and recorded on a computer-readable recording medium. The computer-readable recording medium may include program instructions, data files, data structures, and the like alone or in combination. The program instructions recorded on the computer-readable recording medium may be program instructions specially designed and configured for the disclosure or program instructions known and available to those skilled in the art of computer software. Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions, such as a ROM, a RAM, and a flash memory. Examples of the program instruction include not only machine language codes such as codes generated by a compiler, but also high-level language codes that can be executed by a computer using an interpreter, or the like. The hardware device may be changed into one or more software modules to perform the processing according to the disclosure, and vice versa.

The specific executions described herein are embodiments and do not limit the scope of the disclosure in any way. For the sake of brevity of the specification, description of conventional electronic components, control systems, software, and other functional aspects of the systems may be omitted. Further, connections or connection members between the components illustrated in the drawings are merely examples of functional connections and/or physical or circuit connections, and may be indicated as various functional connections, physical connections, or circuit connections that are replaceable or additional ones in an actual device. Further, when there is no specific mention such as “essential” and “important,” a corresponding component may not be required for the application of the disclosure.

Further, although the detailed description of the disclosure has been described with reference to the preferred embodiments of the disclosure, it will be understood by those skilled in the art or those with common knowledge in the art that the disclosure can be variously modified and changed without departing from the spirit and technical scope of the disclosure described in the claims to be described later. Therefore, the technical scope of the disclosure should not be limited to the content described in the detailed description of the specification, but should be determined by the claims.

What is claimed is:

1. A method, executed by a performance setting application of a manager terminal, for checking a setting status of multiple light emitting devices, comprising:
acquiring pairing information for the multiple light emitting devices;
displaying setting status information for a first performance according to the acquired pairing information on a setting status interface at a first time point;
determining at least one target seat according to the setting status information for the first performance;
transmitting a setting encouragement message to the determined target seat;
providing feedback content for the setting status information of the first performance at a second time point after transmitting the setting encouragement message; and
changing and storing performance direction data matched with the first performance according to the provided feedback content.

2. The method for checking a setting status of multiple light emitting devices of claim 1, wherein acquiring pairing information includes:
linking with a master kiosk connected to at least one slave kiosk in which performing pairing with the multiple light emitting devices; and
acquiring from the connected master kiosk pairing information performed in at least one slave kiosk connected to the master kiosk.

3. The method for checking a setting status of multiple light emitting devices of claim 1, wherein displaying the setting status information for the first performance includes:
extracting from the pairing information seat information matched with an audience terminal or a light emitting device that has received seat-specific direction data through pairing;
determining the extracted seat information as paired seats;
determining from the pairing information the remaining seat information, excluding the determined paired seats, as non-paired seats; and
displaying a seat layout indicating the paired seats and the non-paired seats.

4. The method for checking a setting status of multiple light emitting devices of claim 3, wherein
displaying the setting status information for the first performance includes:
acquiring a total number of seats sold for the first performance from a performance management server; and
calculating a pairing proportion that is a ratio of a number of the determined paired seats to the total number of seats, and
the seat layout and the pairing proportion are displayed in real time on a setting status interface.

5. The method for checking a setting status of multiple light emitting devices of claim 1, wherein determining target seat includes:
acquiring the performance direction data for the first performance;
determining a first direction scene from the acquired performance direction data;
determining a first main set on a target seat determination interface based on a seat layout on which the first direction scene is indicated;
classifying non-paired seats from the determined first main set; and
determining at least one non-paired seat to be the target seat.

6. The method for checking a setting status of multiple light emitting devices of claim 1, wherein
transmitting the setting encouragement message includes:
determining either all audience terminals or only audience terminals matched with the determined target seats as recipient terminals, and
determining all audience terminals as the recipient terminals includes generating the setting encouragement message in which the determined target seats are indicated in text format.

7. The method for checking a setting status of multiple light emitting devices of claim 6, wherein the setting encouragement message indicates at least one of floor number, row number, column number, and zone number of the target seats in an auditorium for the first performance.

8. The method for checking a setting status of multiple light emitting devices of claim 6, wherein transmitting the setting encouragement message to all audience terminals as the recipient terminals includes:
extracting first seat information matched with a first audience terminal;
comparing the target seats included in the setting encouragement message with the extracted first seat information; and
controlling to provide a pairing guide to the first audience terminal when the at least one of the target seats matches with the first seat information.

9. The method for checking a setting status of multiple light emitting devices of claim 5, wherein providing the feedback content includes:
generating the feedback content indicating a first pairing proportion at the first time point and a second pairing proportion at the second time point; and
providing an interface for shifting the first main set to another zone when the second pairing proportion is equal to or smaller than a preset criterion.

10. The method for checking a setting status of multiple light emitting devices of claim 9, wherein changing and storing the performance direction data matched with the first performance includes:
shifting the first main set to a second main set in which the number of non-paired seats is smaller than a preset criterion; and
changing and storing the performance direction data so that the first direction scene is performed in the second main set.

11. A system for checking a setting status of multiple light emitting devices, the system being linked to at least one kiosk providing a pairing service to a light emitting device and an audience terminal, wherein
a manager terminal includes at least one memory and at least one processor, and
at least one application stored in a memory of a manager terminal and executed by the processor to provide a performance setting service including:
acquiring pairing information for the multiple light emitting devices;
displaying setting status information for a first performance according to the acquired pairing information on a setting status interface at a first time point;
determining at least one target seat based on the setting status information for the first performance;
transmitting a setting encouragement message based on the determined target seat;
providing feedback content for the setting status information of the first performance at a second time point after transmitting the setting encouragement message; and
changing and storing performance direction data matched with the first performance according to the provided feedback content.
